(19) United States
(12) Patent Application Publication
(10) Pub. No.: US 2020/0201088 A1
(43) Pub. Date: Jun. 25, 2020

(54) VIEWING ANGLE CONTROL FILM AND DISPLAY DEVICE USING THE SAME

(71) Applicant: CHI HSIANG OPTICS Co., LTD., Zhubei City (TW)

(72) Inventor: PO-HUNG YAO, Hsinchu City (TW)

(21) Appl. No.: 16/724,352

(22) Filed: Dec. 22, 2019

(30) Foreign Application Priority Data
Dec. 22, 2018 (TW) 107146627

(51) Int. Cl. G02F 1/13; G02F 1/1337; G02F 1/1335

(52) U.S. Cl. CPC G02F 1/1323; G02F 1/133606; G02F 1/133753

(57) ABSTRACT

A viewing angle control film includes two opposite transparent electrodes and a modulation layer. The modulation layer is disposed between the two opposite transparent electrodes and the modulation layer includes a plurality of microstructures, a plurality of first optical coatings and a plurality of liquid crystal molecules. The microstructures are spaced apart. Each of the microstructures includes at least a first side and a second side opposite to each other. There is a spacing space between the first side of each of the microstructures and the second side of another adjacent microstructure. The plurality of first optical coatings is respectively coated on at least one of the first side and the second side of each of the microstructures. The plurality of liquid crystal molecules is disposed in the spacing spaces. A display device using the viewing angle control film is also provided.

### TECHNICAL FIELD

The invention relates to an optical film, and more particularly to a viewing angle control film and a display device and a projection screen using the viewing angle control film.

### BACKGROUND

At present, the anti-peep function in a display device is generally realized by disposing a light exit angle control film on the display panel or the backlight module to filter out the large-angle light, so that others cannot view the image in a direction more than 30 degrees from the left and right sides of the screen, and thereby providing data protection. The optical film capable of controlling the light divergence angle on the market is mainly composed of a fixed light-absorbing grating structure, such as a 3M-based anti-peep film, which is mainly used to standardize the divergence range of the light. After the grating structure is fixed, the optical characteristics are fixed and not adjustable. In order to make the light divergence angle adjustable, it is necessary to employ other optical components or optical modules in the module architecture, and the optical film cannot be used alone.

An electronic switchable privacy film is disclosed in Taiwan Patent Publication No. 201319639. The electronic switchable privacy film includes a pair of transparent electrodes facing each other, a microstructured rib disposed between the transparent electrodes, and an electronic switchable material. The microstructured rib forms a series of alternating ribs and a channel, and the electronic switchable material is disposed in the channel. When the transparent electrodes apply an electric field, the electronic switchable material can be modulated between a high light scattering state and a low light scattering state. However, the electronic switchable privacy film of such a structure has a turbidity of at least 70% from a viewing angle of about 30° to 45° in a privacy mode, and the image is not completely black although the turbidity is 70% or more. As a result, the anti-peep effect is limited.

### SUMMARY

The invention provides a viewing angle control film and a display device using the same. The switching between the anti-peep mode and the sharing mode is greatly improved by using the single viewing angle control film.

The viewing angle control film provided by the present invention includes two opposite transparent electrodes and a modulation layer. The modulation layer is disposed between the two opposite transparent electrodes and the modulation layer includes a plurality of microstructures, a plurality of first optical coatings and a plurality of liquid crystal molecules. The microstructures are spaced apart. Each of the microstructures includes at least a first side and a second side opposite to each other. There is a spacing space between the first side of each of the microstructures and the second side of another adjacent microstructure. The plurality of first optical coatings is respectively coated on at least one of the first side and the second side of each of the microstructures. The plurality of liquid crystal molecules is disposed in the spacing spaces.

In an embodiment of the invention, the microstructures are composed of a light-transmitting polymer material. The first optical coatings are disposed on the first sides and the second sides. The first optical coatings are a light absorbing layer.

In an embodiment of the invention, the modulation layer further includes a plurality of second optical coatings. Each of the first optical coatings and each of the second optical coatings are respectively disposed on the firs side and the second side of each of the microstructures. The first optical coatings are a light absorbing layer. The second optical coatings are a light scattering layer.

In an embodiment of the invention, the microstructures are composed of an opaque polymer material. The first optical coatings are a light scattering reflective layer.

In an embodiment of the invention, a cross section of each of the microstructures is selected from a group consisting of a triangle, a rectangle, a trapezoid and a polygon or a combination thereof.

In an embodiment of the invention, the liquid crystal molecules are selected from a group consisting of a cholesteric liquid crystal and a polymer dispersed liquid crystal.

In an embodiment of the invention, each of the liquid crystal molecules has a first optical state and a second optical state. An electric field is formed between the transparent electrodes when a driving voltage is provided. The electric field switches the liquid crystal molecules from the first optical state to the second optical state.

In an embodiment of the invention, each of the transparent electrodes includes a transparent substrate and a transparent conductive layer. The two transparent conductive layers of the two transparent electrodes are opposite to each other. The modulation layer is disposed between the two transparent conductive layers.

In an embodiment of the invention, the viewing angle control film further includes a reflective layer disposed on a side of one of the transparent electrodes away from the modulation layer.

In an embodiment of the invention, the viewing angle control film is adapted to receive an image light beam from a projection device, so the viewing angle control film is used as a projection screen.

In an embodiment of the invention, the viewing angle control film further includes a reflective layer disposed on a side of one of the transparent electrodes away from the modulation layer. The two opposite transparent electrodes and the modulation layer are located between the reflective layer and the projection device.

The display device provided by the present invention includes a backlight module, the aforementioned viewing angle control film and a display panel. The backlight module has a light exit surface. The viewing angle control film is disposed opposite to the light exit surface of the backlight module. The display panel is disposed on the viewing angle control film, so the viewing angle control film is located between the display panel and the backlight module.

In the present invention, by disposing the liquid crystal molecules in the spacing between the microstructures using the driving voltage to modulate the arrangement of the liquid crystal molecules, a controllable function is achieved in which the incident light can be switched between a small divergence angle and a large divergence angle. Further, the anti-peep effect is improved by the arrangement of the light absorbing layer. Further, the convenience of switching between the anti-peep and sharing can be greatly improved when the viewing angle control film is applied to a display device. Further, a projection screen can have an increased display contrast and function as a compartment with a privacy effect when the viewing angle control film is applied to the projection screen. Thus, the viewing angle control film of the embodiment of the invention has a wide application range and is diverse, and has high cost efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional structural view of a viewing angle control film according to a first embodiment of the present invention;

FIGS. 2A and 2B are schematic views showing the light travel of a viewing angle control film in different driving voltage states according to a first embodiment of the present invention;

FIGS. 3A and 3B are schematic views showing the light travel of a viewing angle control film in different driving voltage states according to a second embodiment of the present invention;

FIGS. 4A and 4B are schematic views showing the light travel of a viewing angle control film in different driving voltage states according to a third embodiment of the present invention;

FIG. 5 is a schematic view of a viewing angle control film applied to a display device according to an embodiment of the present invention; and

FIGS. 6A and 6B are respective schematic views of a viewing angle control film in different driving voltages and applied to a projection screen according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

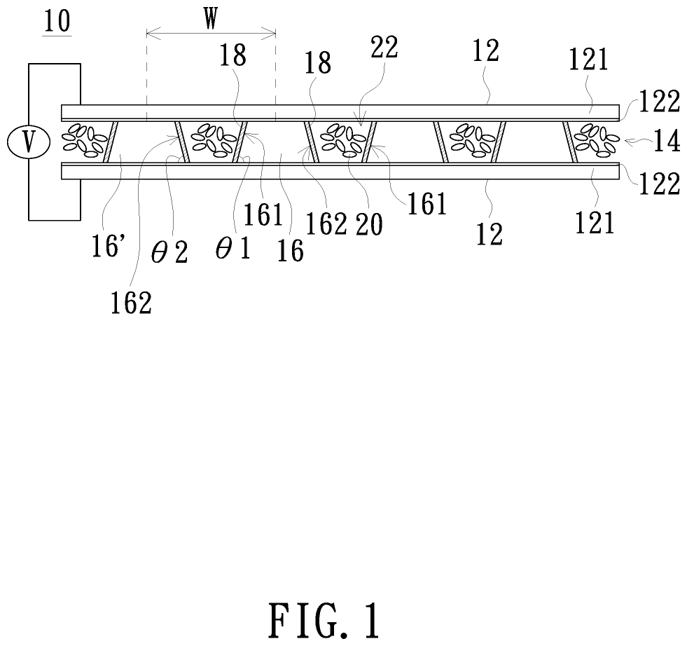

FIG. 1 is a schematic cross-sectional structural view of a viewing angle control film according to a first embodiment of the present invention. As shown in FIG. 1, the viewing angle control film 10 includes two opposite transparent electrodes 12 and a modulation layer 14. In one embodiment, each of the transparent electrodes 12 includes a transparent substrate 121 and a transparent conductive layer 122. The two transparent conductive layers 122 are opposite to each other, and the modulation layer 14 is disposed between the two opposite transparent conductive layers 122. The modulation layer 14 includes a plurality of microstructures 16, 16′, a plurality of first optical coatings 18, and a plurality of liquid crystal molecules 20. The plurality of microstructures 16 are spaced apart. In one embodiment, the microstructure 16 may be elongated. The cross section of the microstructure 16 may be trapezoidal having a first side 161 and a second side 162 opposite to each other, but is not limited thereto. The cross section of the microstructure 16 may also be a single geometric shape such as a triangle, a rectangle, or a polygon or formed by a plurality of shapes. As shown in FIG. 1, the first side 161 of each microstructure 16 is opposite the second side 162 of another adjacent microstructure 16′, and there is a spacing space 22 between the opposite first side 161 and the second side 162. The first optical coating 18 is disposed on at least one of the first side 161 and the second side 162. In this embodiment, the first optical coating 18 is disposed on the first side 161 and the second side 162. Further, the plurality of liquid crystal molecules 20 is disposed in the spacing space 22. In one embodiment, the spacing space 22 is filled with a light-transmitting polymer material mixed with the liquid crystal molecules 20. The transparent conductive layer 122 is composed of indium tin oxide, nano silver wire, a metal mesh or a metal thin film.

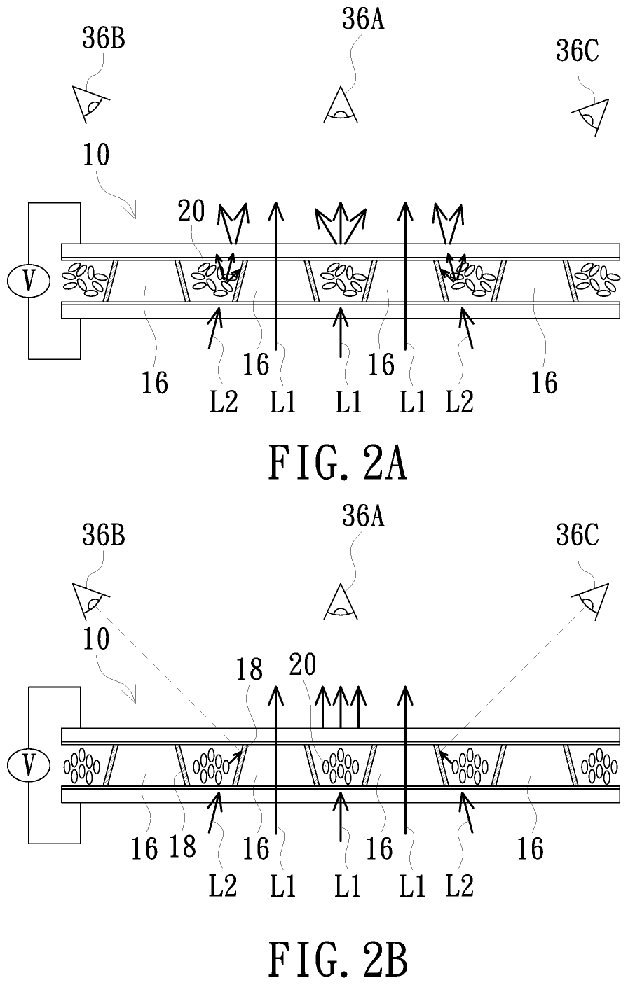

Follow the above description. In one embodiment, the microstructure 16 (or 16′, hereunder only the microstructure 16 is used for the description) is composed of a light-transmitting polymer material, and the first optical coating 18 is a light absorbing layer. The liquid crystal molecule 20 is selected from one of the cholesteric liquid crystal or the polymer dispersed liquid crystal. The liquid crystal molecule 20 has a first optical state and a second optical state. An electric field is formed between the two transparent conductive layers 122 when a driving voltage is supplied to the two transparent conductive layers 122, and the electric field causes the liquid crystal molecules 20 to switch from the first optical state to the second optical state. FIGS. 2A and 2B are schematic views showing the light travel of a viewing angle control film in different driving voltage states according to a first embodiment of the present invention. In one embodiment, when the two transparent conductive layers 122 are not supplied with a driving voltage as shown in FIG. 2A, the liquid crystal molecules 20 are in the first optical state in which the liquid crystal molecules 20 are non-aligned and therefore the refractive index distribution is in a non-aligned state. As such, the straight-in incident light L1 and the large-angle incident light L2 are scattered while passing through the liquid crystal molecules 20. As a result, the light exit angle is large and therefore the viewing angle range is large. Alternatively, when the two transparent conductive layers 122 are supplied with a driving voltage, the liquid crystal molecules 20 are in the second optical state in which the liquid crystal molecules 20 are aligned and therefore the refractive index distribution is in an aligned state. As such, the straight-in incident light L1 is not scattered while passing through the liquid crystal molecules 20. As a result, the light exit angle of the straight-in incident light L1 is equal to the light incident angle thereof, and the large-angle incident light L2 is absorbed by the first optical coating 18 on the first side 161 and the second side 162 of the microstructure 16.

For example, the incident light L1, L2 is incident from the lower side of the viewing angle control film 10. When the liquid crystal molecules 20 are non-aligned as shown in FIG. 2A, a portion of the straight-in incident light L1 passes through the transparent microstructures 16, and a portion of the straight-in incident light L1 and the large-angle incident light L2 are scattered by the liquid crystal molecules 20. As such, the first viewer 36A directly above the viewing angle control film 10 and the second viewer 36B and the third viewer 36C on the upper two sides (for example, about 30 degrees of viewing angle) all can view a bright image, and thereby presenting a sharing mode. Alternatively, when the liquid crystal molecules 20 are aligned due to the transparent conductive layers 122 are supplied with a driving voltage as shown in FIG. 2B, the straight-in incident light L1 passes through the transparent microstructures 16 and the liquid crystal molecules 20, so that the first viewer 36A directly above the viewing angle control film 10 can view the relatively bright image. In contrast, the large-angle incident light L2 cannot pass through the liquid crystal molecules 20 and is further absorbed by the first optical coating 18 as the light absorbing layer, so that the second viewer 36B and the third viewer 36C on the upper two sides of the viewing angle control film 10 can only view a black image due to facing the first optical coatings 18, and thereby presenting an anti-peep mode. As such, the anti-peep effect is good and the anti-peep mode has a privacy protection effect.

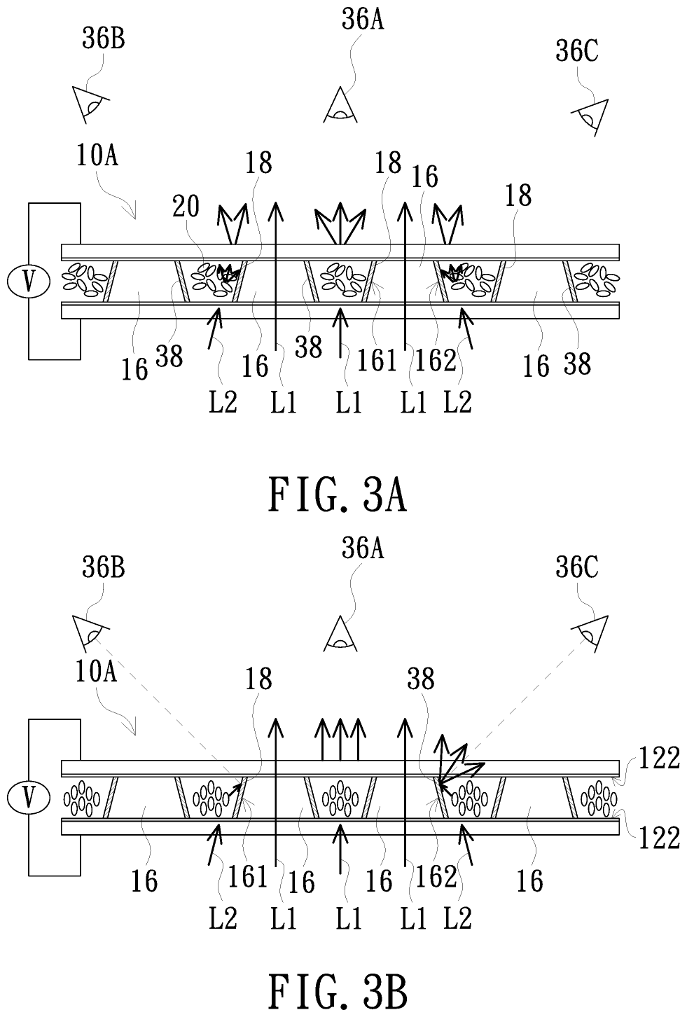

FIGS. 3A and 3B are schematic views showing the light travel of a viewing angle control film in different driving voltage states according to a second embodiment of the present invention. As shown in FIGS. 3A and 3B, the viewing angle control film 10A of the second embodiment differs from the viewing angle control film 10 of the first embodiment in that the viewing angle control film 10A of the second embodiment further includes a second optical coating 38. Specifically, the first optical coating 18 is a light absorbing layer disposed on the first side 161 of the microstructure 16, and the second optical coating 38 is a light scattering layer disposed on the second side 162 of the microstructure 16. When the liquid crystal molecules 20 are non-aligned as shown in FIG. 3A, similar to the first embodiment, the first viewer 36A directly above the viewing angle control film 10 and the second viewer 36B and the third viewer 36C on the upper two sides (for example, about 30 degrees of viewing angle) all can view a bright image, and thereby presenting a sharing mode. Specifically, the image viewed by the first viewer 36A is the brightest, the image viewed by the third viewer 36C whose line of sight faces the second optical coating 38 on the second side 162 is second, and the image viewed by the second viewer 36B whose line of sight faces the first optical coating 18 on the first side 161 is the darkest.

When the liquid crystal molecules 20 are aligned due to the transparent conductive layers 122 are supplied with a driving voltage as shown in FIG. 2B, the first viewer 36A directly above the viewing angle control film 10A can view the brightest image, and the third viewer 36C having the line of sight facing the second optical coating 38 on the second side 162 of the microstructure 16 can view the second brightest image, while the second viewer 36B having the line of sight facing the first optical coating 18 on the first side 161 of the microstructure 16 can only view a black image due to that the light incident on the first optical coating 18 is absorbed. The design in which a large-angle viewer on one side can view the image and a large-angle viewer on the other side cannot view the image has a light-emitting characteristic with an asymmetrical viewing angle.

Please refer to FIG. 1 again. In the above embodiment, the spacing W between the adjacent microstructures 16 and 16′ and the inclination of the first side 161 and the second side 162 of the microstructures 16, 16′ affect the light exit control of the viewing angle control film 10 (10A). For example, when in the sharing mode in which the inclination angles of the first side 161 and the second side 162 are relatively smaller (i.e., the angles θ1, θ2 between the first side 161 and the second side 162 and the horizontal direction are relatively small), the scattering angle is large and light can exit in a large angle. When the spacing W between the adjacent microstructures 16 and 16′ is relatively small, the privacy mode has less light penetration, and thus the image is dark.

In the first embodiment and the second embodiment, since the microstructure 16 is composed of a light-transmitting polymer material and the first optical coating 18 (light absorbing layer) is coated on the first side 161 and/or the second side 162 of the microstructure 16, the privacy protection effect is actually achieved; however, the invention is not limited thereto. In another embodiment, the microstructure 16 is composed of an opaque polymer material. As such, the first optical coating 18 (light absorbing layer) can be omitted in this embodiment due to that the opaque polymer material itself has a light absorbing effect. Whether the microstructure 16 transmits light substantially affects the light extraction efficiency of the entire viewing angle control film 10 (10A). For example, the viewing angle control film 10 (10A) having the microstructure 16 composed of the light-transmitting polymer material has high light extraction efficiency, and the viewing angle control film 10A having the microstructure 16A composed of the opaque polymer material has low light extraction efficiency. However, in the sharing mode, the microstructure 16A composed of the opaque polymer material does not affect whether a large-angle viewer can view the image.

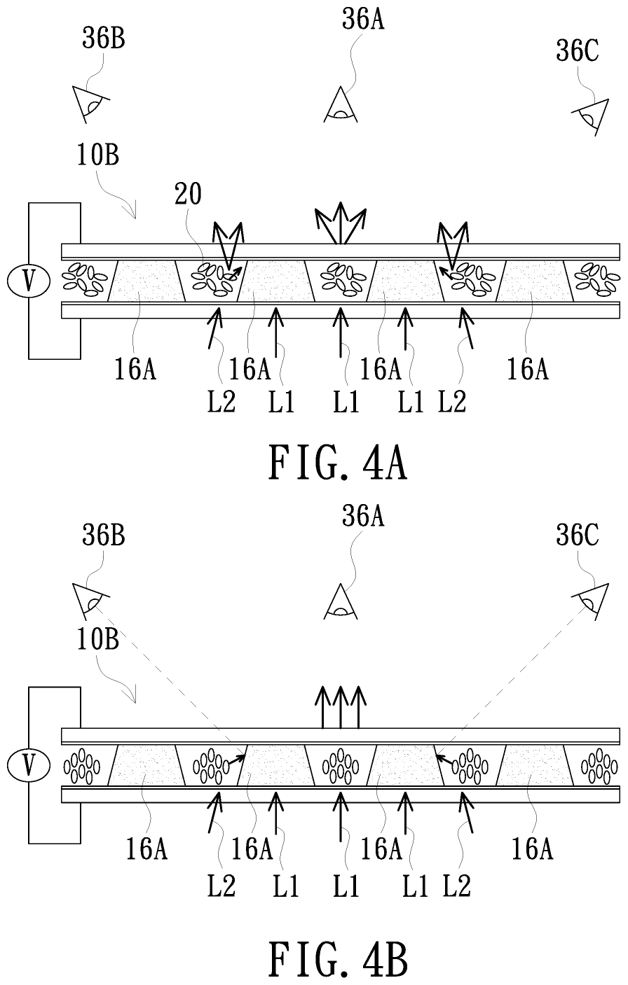

FIGS. 4A and 4B are schematic views showing the light travel of a viewing angle control film in different driving voltage states according to a third embodiment of the present invention. When the microstructure 16A of the viewing angle control film 10B is composed of an opaque polymer material and the non-aligned liquid crystal molecules 20 scatter the incident light L1, L2 as shown in FIG. 4A, the first viewer 36A, the second viewer 36B and the third viewer 36C all can view a bright image. When the liquid crystal molecules 20 are aligned as shown in FIG. 4B, the straight-in incident light L1 cannot pass through the opaque microstructure 16A but can pass through the liquid crystal molecules 20, so that the first viewer 36A directly above the viewing angle control film 10B can view a bright image. The large-angle incident light L2 cannot pass through the liquid crystal molecules 20 and the microstructures 16A, so that the second viewer 36B and the third viewer 36C on both sides above the viewing angle control film 10B can only view a black image.

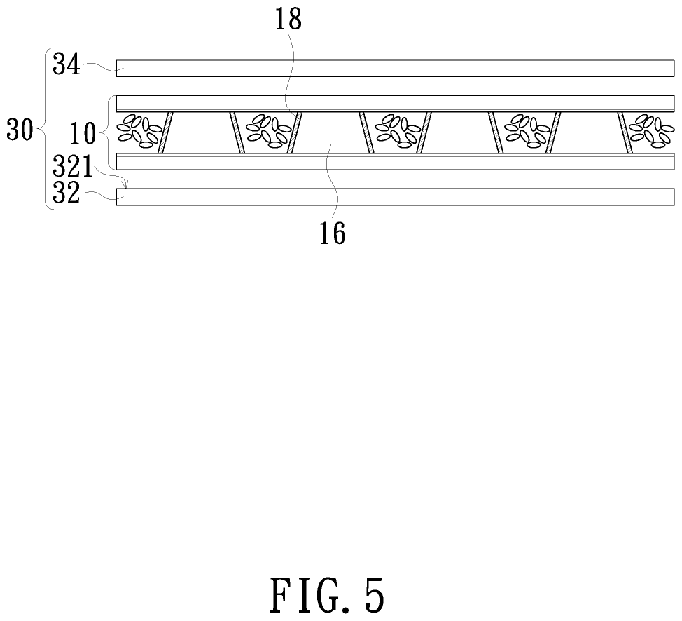

FIG. 5 is a schematic view of a viewing angle control film applied to a display device according to an embodiment of the present invention. The display device 30 includes a backlight module 32, a viewing angle control film 10 (or 10A, 10B, and hereunder is indicated by 10), and a display panel 34. The backlight module 32 has a light exit surface 321. The display panel 34 is, for example, a liquid crystal display panel. The viewing angle control film 10 is disposed between the backlight module 32 and the display panel 34 and disposed opposite to the light exit surface 321. The incident light L1, L2 (not shown) provided by the light exit surface 321 of the backlight module 32 is incident from the lower side of the viewing angle control film 10. By the control of the driving voltage, the viewing angle control film 10 can be switched between a sharing mode and an anti-peep mode, in which two modes the viewing angle of the image of the display device 30 can be switched, and thereby realizing the switching of the anti-peep and sharing functions of the display device 30. The display device 30 of the present embodiment improves the inconvenience in which the conventional anti-peep and sharing function switching must be realized by disposing the optical film on or removing the optical film from the display panel 34.

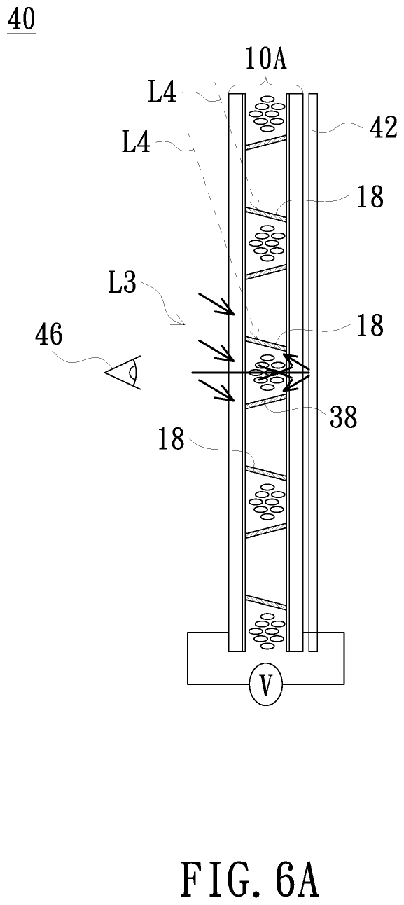

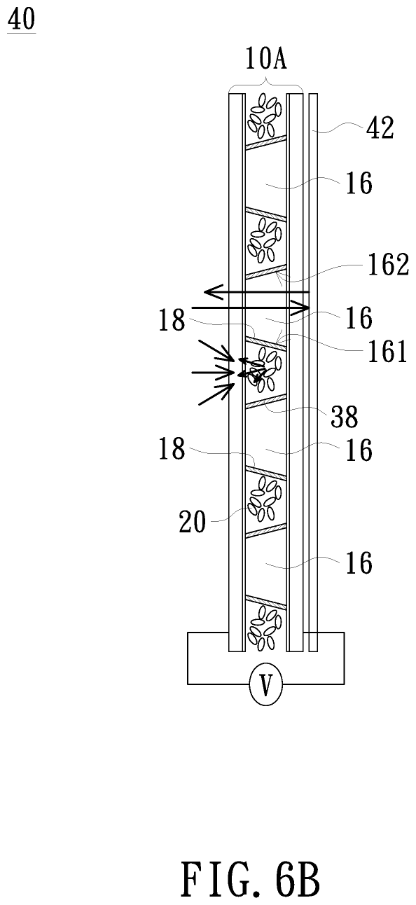

FIGS. 6A and 6B are respective schematic views of a viewing angle control film in different driving voltages and applied to a projection screen according to an embodiment of the present invention. FIGS. 6A and 6B are illustrated by taking the viewing angle control film 10A in the second embodiment as an example. As shown, the projection screen 40 includes a reflective layer 42 and a viewing angle control film 10A. The viewing angle control film 10A and the reflective layer 42 are oppositely disposed. The projection screen 40 is configured to receive an image light beam L3 of a projection device (not shown). The viewing angle control film 10A is disposed between the reflective layer 42 and the projection device. In the viewing angle control film 10A, the first side 161 of the microstructure 16 has a first optical coating 18 and the second side 162 has a second optical coating 38, wherein the first optical coating 18 is a light absorbing layer and the second optical coating 38 is a light scattering layer. In one embodiment, the projection device has a top-mounted configuration and is disposed upper and in the front of the projection screen 40. When the liquid crystal molecules 20 are aligned due to the transparent conductive layers 122 are supplied with driving voltage as shown in FIG. 6A, a portion of the image light beam L3 passes through the liquid crystal molecules 20, reaches the reflective layer 42, and is reflected by the reflective layer 42 to the viewer 46. Further, by the selection and adjustment of the spacing between the microstructures 16, a portion of the image light beam L3 obliquely incident on the viewing angle control film 10A of the projection device is incident on the second optical coating 38 and is then scattered to the viewer by the second optical coating 38. Meanwhile, the external ambient light beam L4, such as the light beam emitted by a fluorescent tube, is incident on the first optical coating 18 and is absorbed when entering the viewing angle control film 10A. As such, the light beam viewed by the viewer is all from the image light beam L3 without being affected by the external ambient light beam L4, thereby having high viewing contrast.

On the other hand, when the liquid crystal molecules 20 of the viewing angle control film 10A of the projection screen 40 are non-aligned as shown in FIG. 6B, the external ambient light beam L4 is first scattered by the liquid crystal molecules 20 before reaching the first optical coating 18 or the second optical coating 38. A portion of the scattered light beam is absorbed by the first optical coating 18 and a portion of the scattered light beam is reflected by the second optical coating 38; as such the entire viewing angle control film 10A is atomized.

In one embodiment, if the projection screen 40 is used as a compartment, the viewing angle control film 10A has an opaque privacy shielding effect when the viewing angle control film 10A is atomized. When the liquid crystal molecules 20 are aligned due to the transparent conductive layers 122 are supplied with the driving voltage, the display of the projection screen 40 has a high contrast effect by the viewing angle control film 10A.

The reflective layer 42 may be directly formed on the outer surface of the transparent substrate 121 of one of the transparent electrodes 12, or the reflective layer 42 may be a reflective member located outside the transparent electrode 12.

Follow the above description. The microstructure 16 may be composed of a light-transmitting polymer material or an opaque polymer material when the viewing angle control film 10A is applied to the projection screen 40. In an embodiment, when the microstructure 16 is composed of a black opaque polymer material, the arrangement of the first optical coating 18 as a light absorbing layer may be omitted and only the second optical coating 38 as a light scattering layer may be disposed on the second side 162 of the microstructure 16. In another embodiment, when the microstructure 16 is composed of a white opaque polymer material, the arrangement of the third optical coating 38 as a light scattering layer may be omitted and only the first optical coating 18 as a light absorbing layer is disposed on the first side 161 of the microstructure 16.

In the present invention, by disposing the liquid crystal molecules in the spacing between the microstructures using the driving voltage to modulate the arrangement of the liquid crystal molecules, a controllable function is achieved in which the incident light can be switched between a small divergence angle and a large divergence angle. Further, the anti-peep effect is improved by the arrangement of the light absorbing layer. Further, the convenience of switching between the anti-peep and sharing can be greatly improved when the viewing angle control film is applied to a display device. Further, a projection screen can have an increased display contrast and function as a compartment with a privacy effect when the viewing angle control film is applied to the projection screen. Thus, the viewing angle control film of the embodiment of the invention has a wide application range and is diverse, and has high cost efficiency.

The above-mentioned statements are merely preferred embodiments of the present invention, and not intended to limit in any form; although the present invention has been disclosed in the above-mentioned preferred embodiments, being not intended to limit the present invention; any technical person skilled in the art, without departing from the technical scope of the present invention, can make some modifications or revisions to the equivalent embodiments by using above-mentioned methods and technical contents; whatever is without departing from the technical scope of the present invention, depending on the technical spirit of the present invention to make any simple modifications, equivalent changes, and revisions are still within the scope of the present invention.

What is claimed is:

1. A viewing angle control film, comprising:
two opposite transparent electrodes; and
a modulation layer, disposed between the two opposite transparent electrodes, and the modulation layer comprising:
a plurality of microstructures, wherein the microstructures are spaced apart, each of the microstructures comprises at least a first side and a second side opposite to each other, and there is a spacing space between the first side of each of the microstructures and the second side of the another adjacent microstructure;
a plurality of first optical coatings, respectively coated on at least one of the first side and the second side of each of the microstructures; and
a plurality of liquid crystal molecules, disposed in the spacing spaces.

2. The viewing angle control film according to claim 1, wherein the microstructures are composed of a light-transmitting polymer material, the first optical coatings are disposed on the first sides and the second sides, and the first optical coatings are a light absorbing layer.

3. The viewing angle control film according to claim 1, wherein the modulation layer further comprises a plurality of second optical coatings, each of the first optical coatings and each of the second optical coatings are respectively disposed on the first side and the second side of each of the microstructures, the first optical coatings are a light absorbing layer, and the second optical coatings are a light scattering layer.

4. The viewing angle control film according to claim 1, wherein the microstructures are composed of an opaque polymer material, and the first optical coatings are a light scattering reflective layer.

5. The viewing angle control film according to claim 1, wherein a cross section of each of the microstructures is selected from a group consisting of a triangle, a rectangle, a trapezoid and a polygon or a combination thereof.

6. The viewing angle control film according to claim 1, wherein the liquid crystal molecules are selected from a group consisting of a cholesteric liquid crystal and a polymer dispersed liquid crystal.

7. The viewing angle control film according to claim 1, wherein each of the liquid crystal molecules has a first optical state and a second optical state, an electric field is formed between the transparent electrodes when a driving voltage is provided, and the electric field switches the liquid crystal molecules from the first optical state to the second optical state.

8. The viewing angle control film according to claim 1, wherein each of the transparent electrodes comprises a transparent substrate and a transparent conductive layer, the two transparent conductive layers of the two transparent electrodes are opposite to each other, and the modulation layer is disposed between the two transparent conductive layers.

9. The viewing angle control film according to claim 1, further comprising a reflective layer disposed on a side of one of the transparent electrodes away from the modulation layer.

10. The viewing angle control film according to claim 1, wherein the viewing angle control film is adapted to receive an image light beam from a projection device, so the viewing angle control film is used as a projection screen.

11. The viewing angle control film according to claim 10, further comprising a reflective layer disposed on a side of one of the transparent electrodes away from the modulation layer, and the two opposite transparent electrodes and the modulation layer are located between the reflective layer and the projection device.

12. A display device, comprising:
a backlight module, having a light exit surface;
a viewing angle control film according to claim 1, disposed on the light exit surface of the backlight module; and
a display panel, disposed on the viewing angle control film, so the viewing angle control film is located between the display panel and the backlight module.

13. The display device according to claim 12, wherein the microstructures are composed of a light-transmitting polymer material, the first optical coatings are disposed on the first sides and the second sides, and the first optical coatings are a light absorbing layer.

14. The display device according to claim 12, wherein the modulation layer further comprises a plurality of second optical coatings, each of the first optical coatings and each of the second optical coatings are respectively disposed on the first side and the second side of each of the microstructures, the first optical coatings are a light absorbing layer, and the second optical coatings are a light scattering layer.

15. The display device according to claim 12, wherein the microstructures are composed of an opaque polymer material, and the first optical coatings are a light scattering reflective layer.

16. The display device according to claim 12, wherein a cross section of each of the microstructures is selected from a group consisting of a triangle, a rectangle, a trapezoid and a polygon or a combination thereof.

17. The display device according to claim 12, wherein the liquid crystal molecules are selected from a group consisting of a cholesteric liquid crystal and a polymer dispersed liquid crystal.

18. The display device according to claim 12, wherein each of the liquid crystal molecules has a first optical state and a second optical state, an electric field is formed between the transparent electrodes when a driving voltage is provided, and the electric field switches the liquid crystal molecules from the first optical state to the second optical state.

19. The display device according to claim 12, wherein each of the transparent electrodes comprises a transparent substrate and a transparent conductive layer, the two transparent conductive layers of the two transparent electrodes are opposite to each other, and the modulation layer is disposed between the two transparent conductive layers.
